(19) United States
(12) Patent Application Publication
(10) Pub. No.: US 2024/0133585 A1
(43) Pub. Date: Apr. 25, 2024

(54) WATER HEATER ASSEMBLY FOR A RECREATION VEHICLE

(71) Applicant: Haier US Appliance Solutions, Inc., Wilmington, DE (US)

(72) Inventors: Jacob Strader, La Grange, KY (US); Richard Dustin Henderson, La Grange, KY (US)

(21) Appl. No.: 17/972,178

(22) Filed: Oct. 23, 2022

(51) Int. Cl. F24H 1/00; B60R 15/00; E03B 7/12; F24H 9/00

(52) U.S. Cl. CPC F24H 1/009; B60R 15/00; E03B 7/12; F24H 9/0005

(57) ABSTRACT

A water heater assembly for a recreation vehicle is provided. The water heater the assembly includes a tank including an interior configured to hold water within the tank. The tank includes an inlet opening configured to receive a first flow of fluid from an input conduit fluidly connecting a bypass valve to the tank. The tank includes an outlet opening configured to egress the first flow of fluid to a junction. A one-way valve is positioned fluidly between the outlet opening and the junction. A bypass conduit fluidly connects the bypass valve to the junction.

### FIELD OF THE INVENTION

The present subject matter relates generally to water heaters for recreation vehicles.

### BACKGROUND OF THE INVENTION

Recreation vehicles may include water heaters for providing heated water for various cooking and cleaning uses at a recreation vehicle. When the water heater is in sufficiently cold environments (e.g., freezing temperatures), water heaters may require winterizing to prevent damage related to freezing temperatures. However, structures and methods for winterizing may require disassembly of various valves or conduits, or may require accessing the water heater from an interior passenger compartment of the recreation vehicle. Requiring access to the water heater from the interior passenger compartment may require leaving space for a user to open a door or remove components from with the interior of the recreation vehicle, which may undesirably inhibit positioning other appliances, furniture, or accessories at the passenger compartment.

As such, a recreation vehicle and water heater that addresses one or more of these issues would be beneficial.

### BRIEF DESCRIPTION OF THE INVENTION

Aspects and advantages of the invention will be set forth in part in the following description, or may be apparent from the description, or may be learned through practice of the invention.

An aspect of the present disclosure is directed to a water heater assembly for a recreation vehicle. The water heater assembly includes a tank including an interior configured to hold water within the tank. The tank includes an inlet opening configured to receive a first flow of fluid from an input conduit fluidly connecting a bypass valve to the tank. The tank includes an outlet opening configured to egress the first flow of fluid to a junction. A one-way valve is positioned fluidly between the outlet opening and the junction. A bypass conduit fluidly connects the bypass valve to the junction.

Another aspect of the present disclosure is directed to a recreation vehicle. The recreation vehicle includes a passenger compartment, an exterior surface, and a water heater assembly. The water heater assembly includes a tank including an interior configured to hold water within the tank. The tank includes an inlet opening configured to receive a first flow of fluid from an input conduit fluidly connecting a bypass valve to the tank. The tank includes an outlet opening configured to egress the first flow of fluid to a junction. A one-way valve is positioned fluidly between the outlet opening and the junction. A bypass conduit fluidly connects the bypass valve to the junction.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a recreation vehicle according to an exemplary embodiment of the present disclosure.

FIG. 2 provides a front view of a schematic embodiment of the recreation vehicle and water heater in accordance with aspects of the present disclosure;

FIG. 3 provides a top-down view of a schematic embodiment of a water heater in accordance with aspects of the present disclosure;

FIG. 4 provides a top-down view of a schematic embodiment of a water heater in accordance with aspects of the present disclosure;

FIG. 5 provides a top-down view of a schematic embodiment of a water heater in accordance with aspects of the present disclosure; and

FIG. 6 provides a top-down view of a schematic embodiment of a water heater in accordance with aspects of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In order to aid understanding of this disclosure, several terms are defined below. The defined terms are understood to have meanings commonly recognized by persons of ordinary skill in the arts relevant to the present invention. The terms “includes” and “including” are intended to be inclusive in a manner similar to the term “comprising.” Similarly, the term “or” is generally intended to be inclusive (i.e., “A or B” is intended to mean “A or B or both”). The terms “first,” “second,” and “third” may be used interchangeably to distinguish one component from another and are not intended to signify location or importance of the individual components. In addition, as used herein, terms of approximation, such as “approximately,” “substantially,” or “about,” refer to being within a ten percent margin of error.

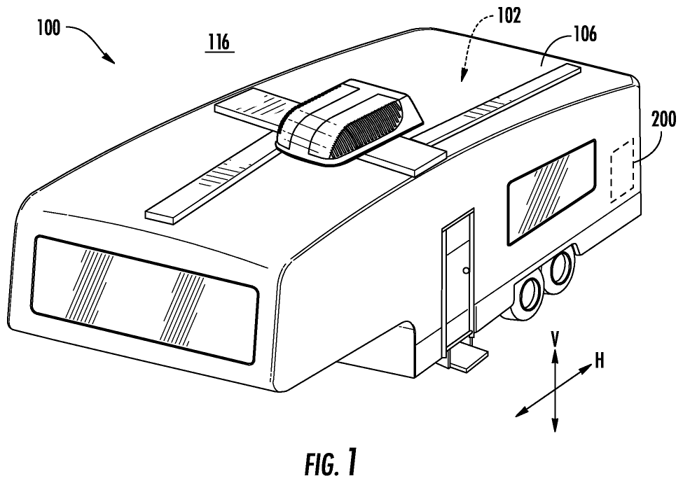

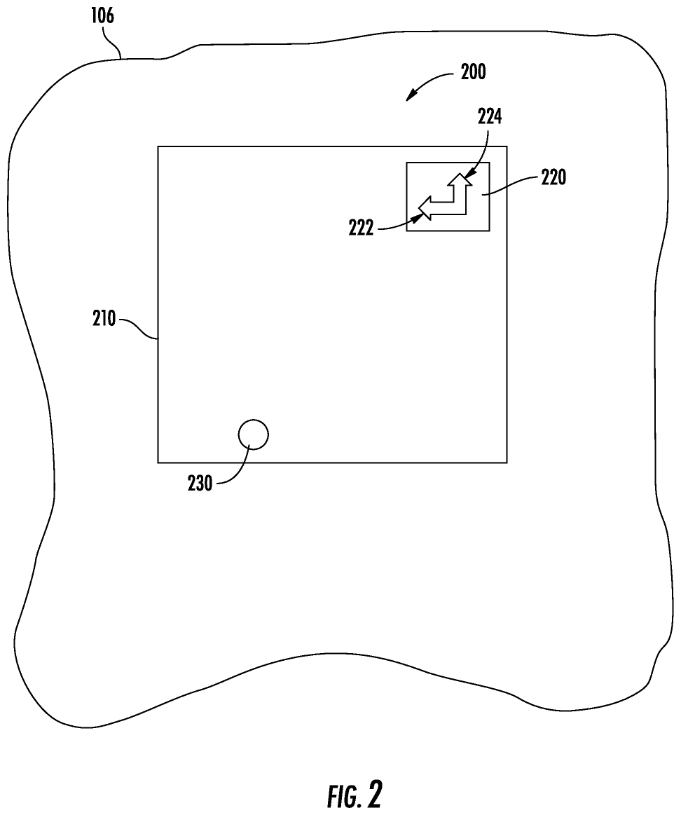

FIG. 1 provides a perspective view of an exemplary recreation vehicle 100 in accordance with the present disclosure. People may employ recreation vehicle 100 for a variety of purposes, including transportation, cooking, eating, sleeping, entertaining, and the like. As such, recreation vehicle 100 defines a passenger compartment 102, which may further include a bed, stove, table, restroom, or multiple compartments for storing items that passengers wish to take with them on their travels. A schematic embodiment of a water heater assembly 200 is depicted and included with the recreation vehicle 100. As further described herein in regard to FIGS. 2-4, the water heater assembly 200 includes a bypass system, such as to allow a user to winterize the water heater 200 to prevent damage due to freezing temperatures. In various embodiments, the water heater assembly 200 may be positioned such as to access various components of the water heater assembly 200 from an exterior 116 of the recreation vehicle 100, such as from an exterior surface 106 of the recreation vehicle 100.

Referring to FIG. 2, a front view of an exemplary schematic embodiment of the recreation vehicle 100 and the water heater assembly 200 is provided. The water heater 200 includes a reservoir or tank 210 forming a plenum at which water is received and stored. A bypass valve 220 is positioned at the water heater 200, such as at a front portion of the water heater 200 proximate to the exterior 116, such as proximate to the exterior surface 106 of the recreation vehicle 100. Embodiments of the water heater 200 and recreation vehicle 100 provided herein may allow front access to the bypass valve 220, such as to allow for less expensive, easier access and installation in contrast to a bypass valve positioned at a backside of the water heater.

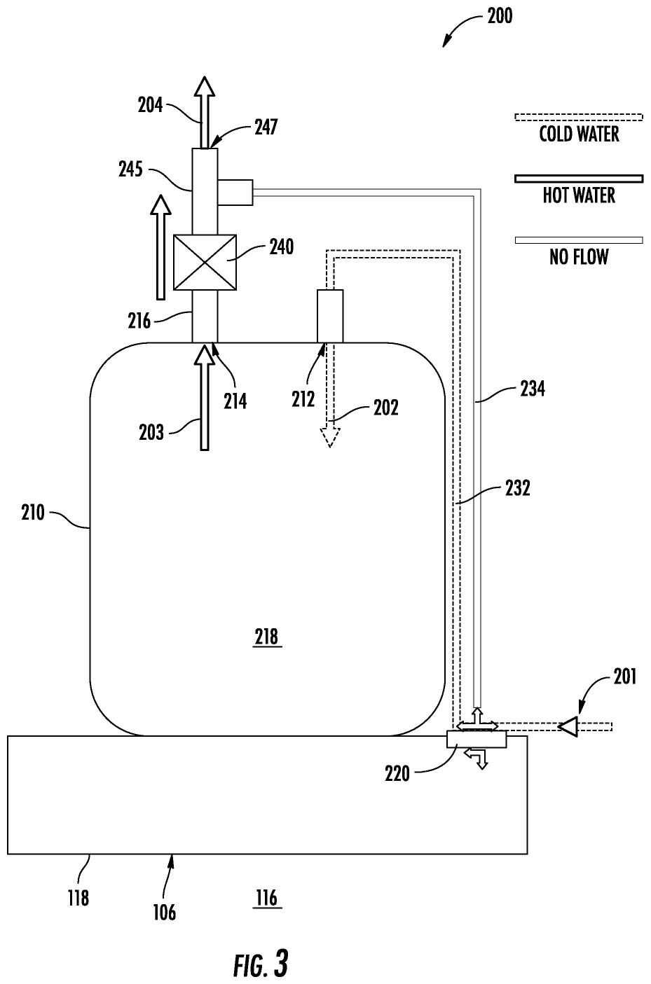

In some embodiments, the water heater 200 includes a drain 230 configured in fluid communication with a hollow interior 218 (FIGS. 3-6) of the tank 210, such as to allow for draining contents (e.g., water) from the tank 210. The drain 230 may be positioned proximate to the exterior 116, such as proximate to the exterior surface 106 of the recreation vehicle 100, such as to allow for contents to be egressed to the exterior 116 of the recreation vehicle 100.

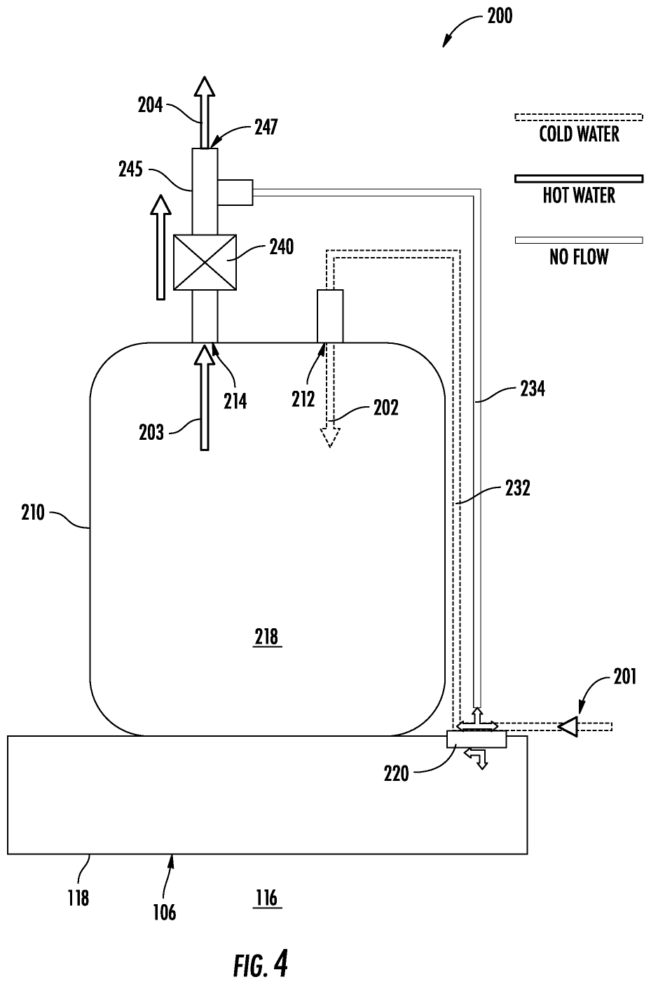

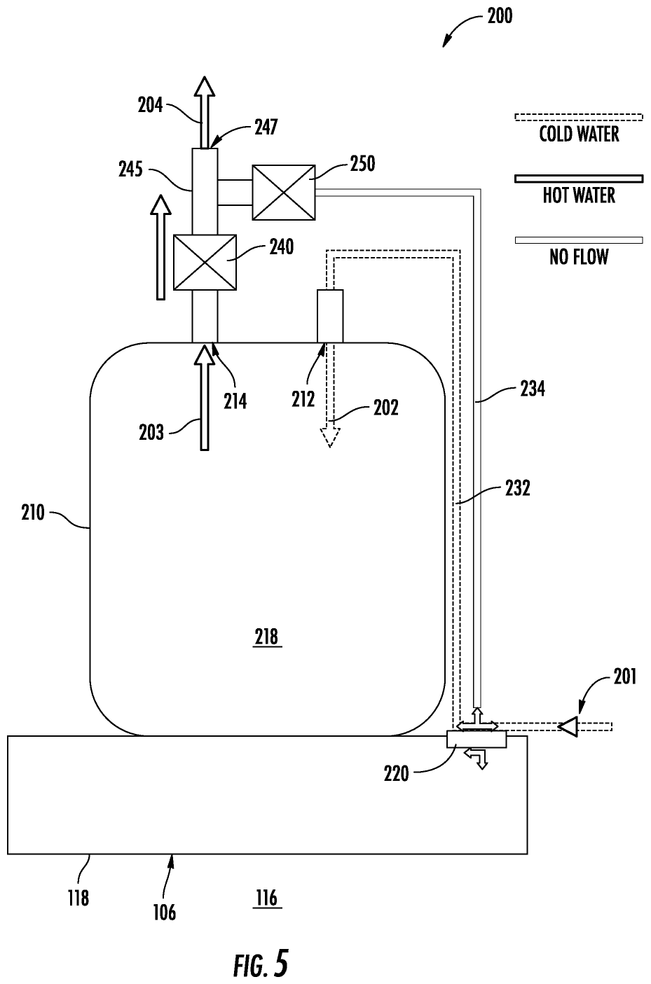

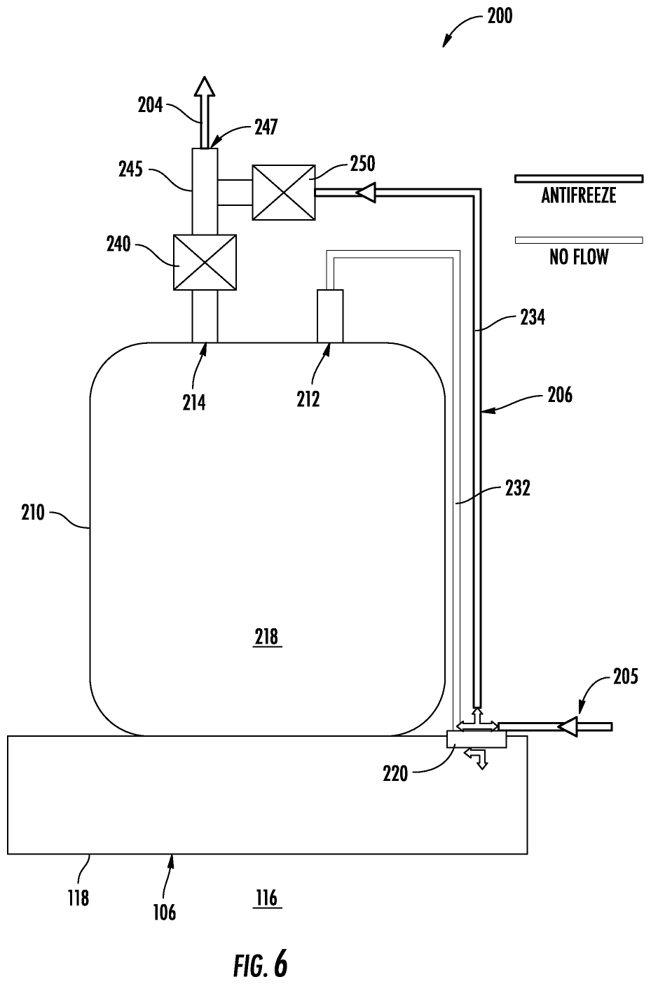

The bypass valve 220 may include a first switch 222 and a second switch 224. The first switch 222 may form a normal operating mode, in which water is received and allowed to flow to the tank 210 for heating, such as further depicted and described in regard to FIG. 3 and FIG. 5. The second switch 224 may form a winterize mode, in which an anti-freeze fluid is allowed to bypass the tank 210 and flow downstream of the tank 210, such as further depicted and described in regard to FIG. 4 and FIG. 6.

The bypass valve 220 may form a three-way bypass valve. For instance, referring to FIGS. 3-6, a supply conduit 201 is fluidly connected to the bypass valve 220 to allow fluid to flow to the bypass valve 220. An input conduit 232 is fluidly connected to the bypass valve 220 and the tank 210 to allow fluid to flow from the bypass valve 220 to the tank 210, such as through inlet opening 212 included at the tank 210. A bypass conduit 234 is fluidly connected to the bypass valve 220 and a junction 245 positioned downstream of the tank 210, such as to allow fluid to flow from the bypass valve 220 to the junction 245 without passing through the tank 210. The junction 245 may form a tee fitting, such as, but not limited to, a pipe tee fitting, a branch tee fitting, a run tee fitting, a reducing tee fitting, a wye tee or lateral tee fitting, or any appropriate type of fitting or junction configured to connect the bypass conduit 234 to another conduit.

Referring still to FIGS. 3-6, the tank 210 may include an outlet opening 214. The outlet opening 214 is configured to allow fluid flow from the tank 210 (e.g., an interior 218 of the tank 210). A one-way valve 240 is positioned at the outlet opening 214, such as to inhibit or prohibit flow from the bypass conduit 234 into the tank 210. The one-way valve 240 may include any appropriate type of valve configured to allow flow in one direction (i.e., from the tank 210 at opening 214 and across the valve 240) and inhibit or prohibit flow in an opposite direction (i.e., from the valve 240 into the tank 210 through opening 214). The one-way valve 240 may include a check valve, a non-return valve, a reflux valve, a retention valve, a foot valve, a ball valve, a diaphragm, a swing or titling disc, or other type of device configured such as described herein.

In some embodiments, the one-way valve 240 is positioned fluidly between the outlet opening 214 at the tank 210 and the junction 245. The junction 245 may form a three-way junction configured to receive anti-freeze fluid from the bypass conduit 234, and further configured to receive heated water from the outlet opening 214 and the one-way valve 240, and to output the anti-freeze fluid and the heated water through an output opening 247.

Referring to FIGS. 5-6, in some embodiments, a second one-way valve 250 is positioned fluidly between the bypass valve 220 and the junction 245. The second one-way valve 245 may positioned along the bypass conduit 234, or at the junction 245 (e.g., between a terminal end of the bypass conduit 234 proximate to the junction 234 and an inlet opening to the junction 245). The second one-way valve 250 may be configured substantially similarly as the one-way valve 240, such as described above. The second one-way valve 250 may inhibit or prohibit back flow of hot water from the outlet opening 214 to the bypass conduit 234.

Referring to FIG. 3 and FIG. 5, in an exemplary embodiment of operation of the water heater 200, the supply conduit 201 is configured to provide a flow of water (e.g., cold or un-heated water) to the bypass valve 220. The bypass valve 220 is positioned in the first switch or position to allow the flow of water through the input conduit 232 and into the tank 210 through the inlet opening 212, such as depicted schematically via arrows 202. The water heater 200 includes any appropriate device for heating the water 202 in tank 210, including, but not limited to, electric devices and/or gas burning devices configured to generate heat and transfer heat to water at the tank 210. Heated water, depicted schematically via arrows 203, is allowed to egress from the outlet opening 214. The one-way valve 240 is configured to allow the heated water 203 to flow from the tank 210 and across the valve 240 to junction 245. Heated water, depicted schematically via arrows 204, is allowed to egress the junction 245 through the output opening 247. Referring to FIG. 4, the second one-way valve 250 may further inhibit or prohibit flow of the heated water into the bypass conduit 234.

Referring to FIG. 4 and FIG. 6, in an exemplary embodiment of operation of the water heater 200, the supply conduit 201 is configured to provide a flow of anti-freeze, depicted schematically via arrows 205, to the bypass valve 220. The bypass valve 220 is positioned in the second switch or position to allow the flow of anti-freeze fluid from the bypass valve 220 to the junction 245, such as depicted schematically via arrows 206, and bypass fluid communication with the tank 210. One-way valve 240 inhibits or prohibits flow of the anti-freeze fluid from the bypass conduit 234 and the junction 245 and into tank 210 through the outlet opening 214. Anti-freeze fluid is allowed to egress the junction 245 through the output opening 247, such as depicted schematically via arrows 207. In some embodiments including the second one-way valve 250 such as depicted in FIG. 6, the valve 250 is configured to permit flow of anti-freeze fluid 206 from the bypass valve 220 to the junction 245, and further to inhibit or prohibit flow from the junction 245 to the bypass valve 220.

Referring to FIGS. 3-6, some embodiments of the recreation vehicle 100 or the water heater 200 may include a front enclosure 118. The front enclosure 118 may include a door or wall, such as a removable wall or articulating structure, configured to allow a user to access the bypass valve 220 from the exterior 116. In some embodiments, at least a portion of the front enclosure 118 forms at least a portion of the exterior surface 116 of the recreation vehicle 100.

It should be appreciated that various embodiments of the water heater 200 may include a fitting 216 positioned at one or more openings 212, 214, junctions 245, valves 220, 240, 250, or other interfaces between one or more conduits 201, 232, 234 and one or more openings 212, 214, junctions 245, or valves 220, 240, 250.

Various embodiments of the water heater 200 provided herein may form a packaged unit, such as a unitary, assembled unit including the tank 210, the bypass valve 220, the input conduit 232, the bypass conduit 234, the one-way valve 240, and the junction 245. Still various embodiments of the water heater 200 may further include the second one-way valve 250 with the packaged, unitary, assembled unit. Such embodiments of the water heater 200 may allow for installation and un-installation of the water heater 200 as a single unit, such that an input (e.g., supply conduit 201) may be connected to provide water or anti-freeze, and an output conduit may fluidly connect to the junction 245 at the output opening 247 to egress or otherwise output fluid from the water heater 200.

Embodiments of the recreation vehicle 100 and water heater 200 provided herein may allow a manufacturer to improve manufacturing efficiency and reduce manufacturing cost by not requiring assembly of a bypass configuration prior to installing a water heater. Additionally, or alternatively, embodiments of the recreation vehicle 100 and water heater 200 provided herein may allow a manufacturer to improve manufacturing efficiency, provide increased interior volume and living space within the passenger compartment 102, and reduce manufacturing cost by not requiring access within the passenger compartment to operate valves at the water heater. Still further, embodiments of the recreation vehicle 100 and water heater 200 may allow for easier access and installation of the water heater.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A water heater assembly for a recreation vehicle, the assembly comprising:
a tank comprising an interior configured to hold water within the tank, the tank comprising an inlet opening configured to receive a flow of fluid from an input conduit fluidly connecting a bypass valve to the tank, the tank comprising an outlet opening configured to egress the flow of fluid to a junction;
a one-way valve positioned fluidly between the outlet opening and the junction; and
a bypass conduit fluidly connecting the bypass valve to the junction.

2. The assembly of claim 1, wherein the bypass conduit fluidly bypasses the tank.

3. The assembly of claim 1, wherein the one-way valve is configured to inhibit flow from the bypass conduit to the tank.

4. The assembly of claim 3, wherein the one-way valve is configured to permit flow from the tank to the junction.

5. The assembly of claim 1, wherein the junction forms a three-way junction configured to receive the flow of fluid from the tank and a flow of fluid from the bypass conduit.

6. The assembly of claim 1, wherein the junction is a tee fitting.

7. The assembly of claim 1, wherein the one-way valve is a check valve, a non-return valve, a reflux valve, a retention valve, a foot valve, a ball valve, a diaphragm, a swing, or a titling disc.

8. The assembly of claim 1, comprising:
a second one-way valve positioned fluidly between the bypass valve and the junction.

9. The assembly of claim 8, wherein the second one-way valve is configured to inhibit back flow of the flow of fluid from the outlet opening of the tank to the bypass conduit.

10. The assembly of claim 8, wherein the second one-way valve is positioned at the bypass conduit.

11. A recreation vehicle, the recreation vehicle comprising:
a passenger compartment;
an exterior surface; and
a water heater assembly, the assembly comprising:
a tank comprising an interior configured to hold water within the tank, the tank comprising an inlet opening configured to receive a flow of fluid from an input conduit fluidly connecting a bypass valve to the tank, the tank comprising an outlet opening configured to egress the flow of fluid to a junction;
a one-way valve positioned fluidly between the outlet opening and the junction; and
a bypass conduit fluidly connecting the bypass valve to the junction.

12. The vehicle of claim 11, comprising:
a front enclosure configured to allow access to the bypass valve from an exterior of the vehicle.

13. The vehicle of claim 11, wherein the water heater assembly is a unitary unit comprising the tank, the bypass valve, the input conduit, the bypass conduit, the one-way valve, and the junction.

14. The vehicle of claim 11, wherein the bypass conduit fluidly bypasses the tank.

15. The vehicle of claim 11, wherein the one-way valve is configured to inhibit flow from the bypass conduit to the tank, and wherein the one-way valve is configured to permit flow from the tank to the junction.

16. The vehicle of claim 11, wherein the junction forms a three-way junction configured to receive the flow of fluid from the tank and a flow of fluid from the bypass conduit.

17. The vehicle of claim 11, the water heater assembly comprising:
a second one-way valve positioned fluidly between the bypass valve and the junction.

18. The vehicle of claim 17, wherein the second one-way valve is configured to inhibit back flow of the flow of fluid from the outlet opening of the tank to the bypass conduit.

19. The vehicle of claim 17, wherein the second one-way valve is positioned at the bypass conduit.

20. The vehicle of claim 17, wherein the water heater assembly is a unitary unit comprising the tank, the bypass valve, the input conduit, the bypass conduit, the one-way valve, the second one-way valve, and the junction.
